(19) United States
(12) Patent Application Publication
(10) Pub. No.: US 2012/0151079 A1
(43) Pub. Date: Jun. 14, 2012

(54) METHODS AND APPARATUS TO MEASURE MEDIA EXPOSURE

(76) Inventors: Jan Besehanic, Tampa, FL (US); Perry Joseph Fisch, Palm Harbor, FL (US)

(21) Appl. No.: 12/966,736

(22) Filed: Dec. 13, 2010

(51) Int. Cl. G06F 15/16

(52) U.S. Cl. 709/231

(57) ABSTRACT

Methods, apparatus, and articles of manufacture to measure media exposure are disclosed. An example method involves extracting and timestamping metadata from streaming media transmissions received at a media device. The metadata identifies at least one of a genre or an artist. In addition, the example method involves identifying demographic information associated with a user of the media device based on an internet protocol (IP) address associated with the media device. The example method also involves generating media exposure information indicating exposure of a demographic segment to at least one of the genre or the artist based on the demographic information and the metadata.

### FIELD OF THE DISCLOSURE

The present disclosure relates generally to monitoring media and, more particularly, to methods and apparatus to measure media exposure.

### BACKGROUND

Traditionally, audience measurement entities determine audience engagement levels for media programming based on registered panel members. That is, an audience measurement entity enrolls people that consent to being monitored into a panel. The audience measurement entity then monitors those panel members to determine media programs (e.g., television programs or radio programs, movies, DVDs, etc.) exposed to those panel members. In this manner, the audience measurement entity can determine exposure measures for different media content based on the collected media measurement data.

### BRIEF DESCRIPTION OF THE DRAWINGS

FIG. 1 depicts an example system that may be used to measure media exposure based on media metadata and user demographics.

FIG. 2 depicts an example media exposure report based on media metadata, user demographics, and media delivery device types.

FIG. 3 depicts an example apparatus that may be used to implement example methods described herein.

FIG. 4 is a flow diagram representative of example machine readable instructions that may be executed to collect media metadata from media.

FIG. 5 is a flow diagram representative of example machine readable instructions that may be executed to determine media exposure measures based on media metadata, user demographics, and media delivery device types.

FIG. 6 is a flow diagram representative of example machine readable instructions that may be executed to determine an audience share metric indicative of percentages of audiences for different device types that accessed the same media content.

FIG. 7 is a flow diagram representative of example machine readable instructions that may be executed to measure popularities of media content across one or more of device type information, geographic locations of audience members, and/or audience member demographics.

FIG. 8 depicts an example audience share metrics data structure that may be used to store and report audience share metrics indicative of percentages of audiences exposed to the same media content via different device types.

FIG. 9 is an example processor system that can be used to execute the example instructions of FIGS. 4-7 to implement the example apparatus of FIG. 3.

### DETAILED DESCRIPTION

Example methods, apparatus, systems, and articles of manufacture disclosed herein may be used to measure media exposure based on media metadata, user demographics, and/or media device types. Some examples disclosed herein may be used to monitor streaming media transmissions received at client devices such as personal computers, portable devices, mobile phones, Internet appliances, and/or any other device capable of playing back media. Some example implementations disclosed herein may additionally or alternatively be used to monitor playback of locally stored media in media devices. Example monitoring processes disclosed herein collect media metadata associated with media content presented via media devices and associate the metadata with demographics information of users of the media devices. In this manner, these example processes may be used to generate detailed exposure measures based on collected media metadata and to associate such exposure measures with respective user demographics.

Example methods, apparatus, systems, and articles of manufacture disclosed herein involve extracting or collecting metadata (e.g., extensible markup language (XML) based metadata or metadata in any other format) from streaming media transmissions (e.g., streaming audio and/or video) at a client device. The metadata may identify one or more of a genre, an artist, a song title, an album name, a transmitting station/server site, etc. As a result, highly granular data can be collected. Whereas in the past ratings were largely tied to television programs or broadcasting stations, example methods, apparatus, systems, and articles of manufacture disclosed herein can generate ratings for a genre, an artist, a song, an album/CD, a particular transmitting/server site, etc. In some example implementations, metadata collections may be triggered based on tuning change events or media content change events detected in media players, and the collected metadata may be time stamped based on its time of collection. A tuning change or media content change event typically causes a change in information identified by the extracted metadata (e.g., a change in genre, a change in artist, a change in song title, etc.) and is, thus, a good trigger for data collection.

Example methods, apparatus, systems, and articles of manufacture disclosed herein collect demographic information associated with users of client devices based on internet protocol (IP) address associated with those client devices. The media exposure information may then be generated based on the media metadata and the user demographics to indicate exposure measures and/or demographic reach measures for least one of a genre, an artist, an album name, a transmitting station/server site, etc.

Example methods, apparatus, systems, and articles of manufacture disclosed herein may also be used to generate reports indicative of media exposure measures on different types of client devices (e.g., personal computers, portable devices, mobile phones, etc.). For example, a media audience measurement entity may generate first and second media exposure measures. The first media exposure measure is associated with streaming media received at a first device of a first device type (e.g., a portable media device) and is generated based on first metadata extracted from the first streaming media at the first device and/or at similar devices. The second media exposure measure is associated with second streaming media received at a second device of a second device type (e.g., a stationary media device) and is generated based on second metadata extracted from the second streaming media at the second device and/or at similar devices. A report is then generated based on the first and second media exposures to indicate a first exposure measure for consuming a type of media (e.g., a genre) using the first device type and a second exposure measure for consuming the same type of media (e.g., the same genre) using the second device type. Thus, for example, reports indicating the popularity of watching, for instance, sports events on mobile devices can be compared to other popularities of watching sports events on stationary/home devices. Additionally or alternatively, popularities of other types of media across different device types may be compared. Such other types of media may be, for example, news, movies, television programming, on-demand media, Internet-based media, games, streaming games, etc. Such comparisons may be made across any types of devices including, for example, cell phones, smart phones, dedicated portable multimedia playback devices, iPod® devices, tablet computing devices, iPad® devices, standard-definition (SD) televisions, high-definition (HD) televisions, three-dimensional (3D) televisions, stationary computers, portable computers, Internet radios, etc. Any other types of media and/or devices may be analyzed. The report may also associate the first and/or second media exposure measures with demographic segments, age groups, genders, etc. corresponding to the users of the first and second devices. Additionally or alternatively, the report may associate the first and/or second media exposure measures with metric indicators of popularity of artist, genre, song, etc. across one or more user characteristics selected from one or more demographic segment(s), one or more age group(s), one or more gender(s), and/or any other user characteristic(s).

In some example implementations, the media exposure measures may be used to determine demographic reach of streaming media, ratings for streaming media, engagement indices for streaming media, user affinities associated with streaming media, and/or any other audience measure associated with streaming media and/or locally stored media. In some examples, the media exposure measures may be audience share metrics indicative of percentages of audiences for different device types that accessed the same media content. For example, a particular percentage of an audience may be exposed to news content via smart phones, while another percentage of the audience may be exposed to the same news content via stationary televisions.

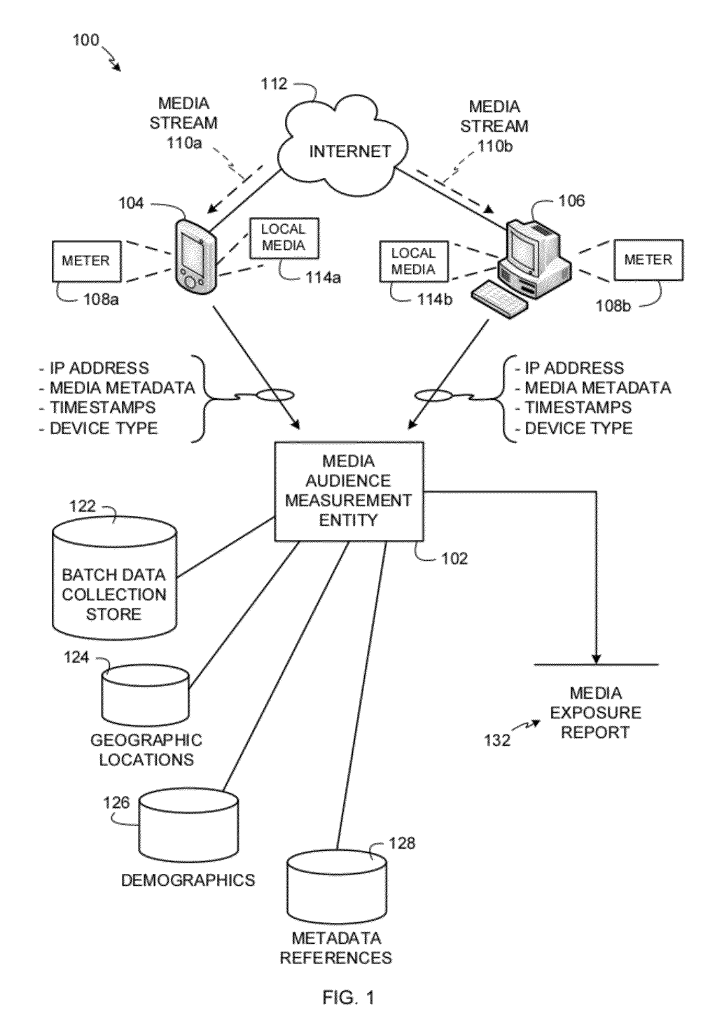

Turning now to FIG. 1, an example system 100 is shown which may be used to determine media exposure measures based on media metadata, user demographics, and/or media device types. In the illustrated example of FIG. 1, the example system 100 includes an example audience measurement entity 102 in communication with a portable media device 104 and a stationary media device 106. As used herein “portable” refers to something intended to be carried or worn by a user and is, thus, dimensioned to be analogous to a cell phone or jewelry. As used herein, “stationary” refers to something intended to remain in a single physical location (e.g., a room). As such, a stationary device is not intended to be carried or worn by an individual. In the illustrated example of FIG. 1, the portable media device 104 may be a smart phone, a portable media player, and/or any other portable device capable of playing back streaming media (e.g., audio and/or video) and/or locally stored media. In the illustrated example of FIG. 1, the stationary media device 106 is shown as a computer, but may be any other media player that is relatively stationary at a home or any other environment. Such stationary media players may be, for example, an Internet radio console, a television, a television set-top box, a personal computer, an Internet appliance, etc.

In the illustrated example of FIG. 1, each of the portable media device 104 and the stationary media device 106 is provided with a respective meter 108a and 108b that monitors respective media streams 110a and 110b (e.g., digital unicast, multicast, or broadcast audio and/or video streams) received via the Internet 112. In the illustrated example of FIG. 1, the meters 108a and 108b are provided by the media audience measurement entity 102 and may be software-based meters, hardware-based meters, and/or may be implemented using any combination of software and/or hardware. In the illustrated example of FIG. 1, the meters 108a and 108b collect media metadata from the media streams 110a and 110b, internet protocol (IP) addresses associated with the media devices 104 and 106, and device types of the media devices 104 and 106. The media metadata collected from the media streams 110a and 110b may be in an XML format or any other format. As shown, the meters 108a and 108b send IP address, media metadata, timestamps (e.g., date/time stamps indicative of when the media metadata was acquired), and device type information to the media audience measurement entity 102. Although some examples disclosed herein are described with respect to the media streams 110a and 110b, such examples may alternatively or additionally be used to monitor and generate exposure measures for local media 114a and 114b that is locally stored in the media devices 104 and 106 (e.g., media programs from an iTunes account, etc.).

In the illustrated example of FIG. 1, the media audience measurement entity 102 includes and/or is in communication with an example batch data collection store 122, an example geographic locations store 124, an example demographics store 126, and an example metadata references store 128. The media audience measurement entity 102 uses the batch data collection store 122 to store metering data (e.g., IP addresses, media metadata, timestamp, and/or device type information) from media devices (e.g., the media devices 104 and 106). In this manner, the media audience measurement entity 102 can retrieve the stored data from the batch data collection store 122 to determine media exposure measures during a post process.

The geographic locations store 124 stores geographic location identifiers in association with IP addresses assigned by Internet service providers (ISPs) to enable Internet devices to download, stream, or otherwise access media (e.g., the media streams 110a-b) via the Internet 112. For example, ISPs may group blocks of IP addresses per geographic locations such that Internet-enabled devices in a particular geographic location can only be assigned IP addresses from a block of IP addresses designated for that particular geographic location. In some example implementations, IP address blocks may be formed based on IP address prefixes (e.g., 98.123.XXX.XXX) such that IP addresses with a particular prefix are assignable only to a particular geographic location. Geographic location identifiers may be one or more of city, county, state, postal code, zip code, zip+4 code, latitude and longitude, or any other information identifying particular geographic locations. In operation, to determine a geographic location of a media device (e.g., one of the media devices 104 or 106), the media audience measurement entity 102 queries the geographic locations store 124 with the IP address of the media device, and the geographic locations store 124 returns the geographic location identifier stored in association with the IP address or with a portion of the IP address such as an IP address prefix (e.g., 98.123.XXX.XXX).

The IP addresses referred to herein may be IP addresses assigned by ISPs directly to media devices if the media devices are directly connected to the ISPs or may be IP addresses assigned by ISPs to gateways or routers through which media devices access Internet services provided by the ISPs. For example, if a user is using a media device within a home (e.g., a mobile or stationary media device in the user's home) that connects to the Internet via a home router or home gateway, the IP address collected in some of the examples disclosed herein is the public IP address assigned by the ISP to the home router or home gateway rather than a private IP address assigned by the home router or home gateway to the home media device. Collecting public IP addresses associated with gateways of residential homes enables identifying household-level demographics using the demographics store 126 as described below. Additionally or alternatively, private IP addresses may also be collected to identify specific users. While a public IP address enables access outside the home to the Internet 112 via the home router or gateway, a private IP address enables the media device to network with the home router or gateway and other devices in the same home network. Similarly, if a user connects a portable media device to a public wireless local area network (WLAN) access point in, for example, a public location (e.g., a coffee shop) at which Internet access is available, the IP address collected by some examples disclosed herein is the public IP address assigned by an ISP to the WLAN access point. Collecting public IP addresses associated with public, commercial, retail, etc. networks enables identifying demographics associated with general geographic locations of those public, commercial, retail, etc. networks using the demographics store 126 as described below. Additionally or alternatively, private IP addresses may also be collected to identify specific users.

The demographics store 126 includes demographics information collected for different geographic locations. In the illustrated example of FIG. 1, the media audience measurement entity 102 accesses the demographics store 126 to retrieve demographics information of users of different media devices (e.g., the media devices 104 and 106). The media audience measurement entity 102 can then associate such demographics information with listening habits of audience members based on media metadata and device type information received from media devices (e.g., the media devices 104 and 106) of those audience members. In some example implementations, the demographics store 126 may be implemented using a proprietary database (e.g., the Nielsen Claritas® database) that stores demographic and census data at different geographic levels of resolution down to a ZIP+4 code geographical resolution. Alternatively, the demographics store 126 may be implemented using a commercial demographics database (e.g., the Experian® database), which stores demographic information including household income level.

The metadata references store 128 of the illustrated example maps meanings or text descriptors to media metadata values using, for example, look up tables. The media audience measurement entity 102 can access the metadata references store 128 to retrieve text descriptors corresponding to media metadata values received from media devices (e.g., the media devices 104 and 106) by submitting queries to the metadata references store 128 including the metadata numeric values received from media devices. For example, some media metadata received at the media audience measurement entity 102 may be in the form of numeric identifiers (e.g., numeric identifiers indicative of different genres) in accordance with an industry standard metadata tagging scheme (e.g., an ID3 tag standard). Such numeric identifiers may be decoded using the look-up tables stored in the metadata references store 128. In some example implementations, the media metadata received by the media audience measurement entity 102 from media devices may already be in self-descriptive text format (e.g., text strings for song titles, albums, artist names, genres, track numbers, etc.). In such example implementations, the media audience measurement entity 102 need not use the metadata references store 128.

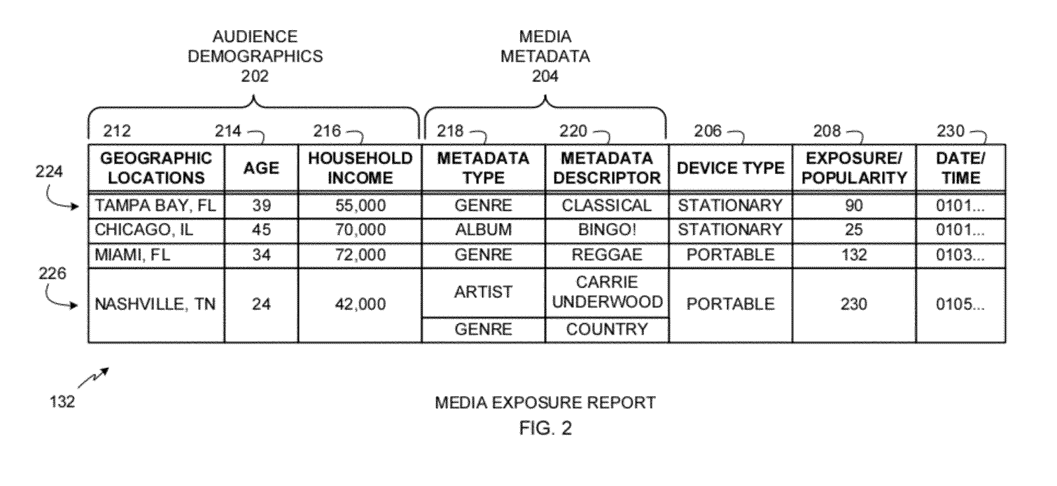

In the illustrated example of FIG. 1, the media audience measurement entity 102 uses the batch data collection store 122, the geographic locations store 124, the demographics store 126, and/or the metadata references store 128 to generate a media exposure report 132 based on the IP addresses, media metadata, and/or device type information received from the media devices 104 and 106. An example implementation of the media exposure report 132 is shown in FIG. 2.

Turning to FIG. 2, the example media exposure report 132 stores audience member demographics information 202 in association with media metadata information 204, device type information 206, and exposure/popularity measures 208 to provide media exposure measures based on media metadata associated with corresponding user-level audience demographics and/or associated with corresponding user-level device type information. In the illustrated example of FIG. 2, the audience member demographics information 202 includes geographic locations 212, age 214, and household income 216. In other example implementations, more, fewer, and/or different types of audience member demographics information may be used in the media exposure report 132.

In the illustrated example of FIG. 2, the media metadata 204 includes metadata type information 218 and metadata descriptors 220. The metadata type information 218 indicates the type of metadata referred to by corresponding entries in the metadata descriptors 220. For example, as shown in FIG. 2, the metadata type information 218 may indicate genre, album, or artist. Although not shown, the metadata type information 218 may additionally or alternatively indicate any other type of metadata including, for example, song title, track number, recording studio, recording date, television program episode, television program identifier, television program title, game title, etc.

In the illustrated example of FIG. 2, each record in the media exposure report 132 may include one or more metadata types 218 and corresponding metadata descriptors 220 for each of the exposure/popularity measures 208. For example, a record 224 includes ‘CLASSICAL’ as an entry in the metadata descriptors 220 stored in association with a metadata type of ‘GENRE’ in the metadata type information 218. Another record 226 includes two metadata types 218 and corresponding metadata descriptors 220. In particular, the metadata types for the record 226 include ‘ARTIST’ and ‘GENRE’ and the corresponding metadata descriptors 220 include ‘CARRIE UNDERWOOD’ for the metadata type ‘ARTIST’ and ‘COUNTRY’ for the metadata type ‘GENRE.’

In the illustrated example of FIG. 2, the device type information 206 stores device type identifiers or descriptors corresponding to media devices (e.g., the media devices 104 and 106 of FIG. 1) monitored by the media audience measurement entity 102 of FIG. 1 (e.g., media devices that send IP address, media metadata, and device type information to the media audience measurement entity 102). In the illustrated example of FIG. 2, the device type information 206 includes entries generally indicating stationary or portable device types. Other device types may additionally or alternatively be used. Such other device types may be more specific descriptions that include, for example, device manufacturer name, device model, streaming capabilities, video playback capabilities, audio playback capabilities, and/or any other information including any combination thereof.

The exposure/popularity measures 208 are determined by the media audience measurement entity 102 of FIG. 1 based on the IP address, media metadata, and/or device type information received from media devices (e.g., the media devices 104 and 106 of FIG. 1). For example, the media audience measurement entity 102 may log or track occurrences of different media metadata associated with each monitored media device and group the logged information based on demographics information and/or device type information. The media audience measurement entity 102 may then associate exposure measures based on the tracked occurrences of different media metadata with corresponding demographics information and/or device types.

Although the example media exposure report 132 is shown in FIG. 2 as having the audience demographics information 202, the media metadata information 204, the device type information 206, and the exposure/popularity measure information 208, the media exposure report 132 may be generated using more, less, or different information. For example, for instances in which media exposure measures based on device type are not desired, the device type information 206 may be omitted from the media exposure report 132. For instances in which media exposure measures based on audience demographics are not desired, the audience demographics 202 may be omitted from the media exposure report 132. In some example implementations, date stamps and/or timestamps 230 may be provided in the media exposure report 132 to indicate dates and/or timeframes for which the exposure/popularity measures 208 were generated.

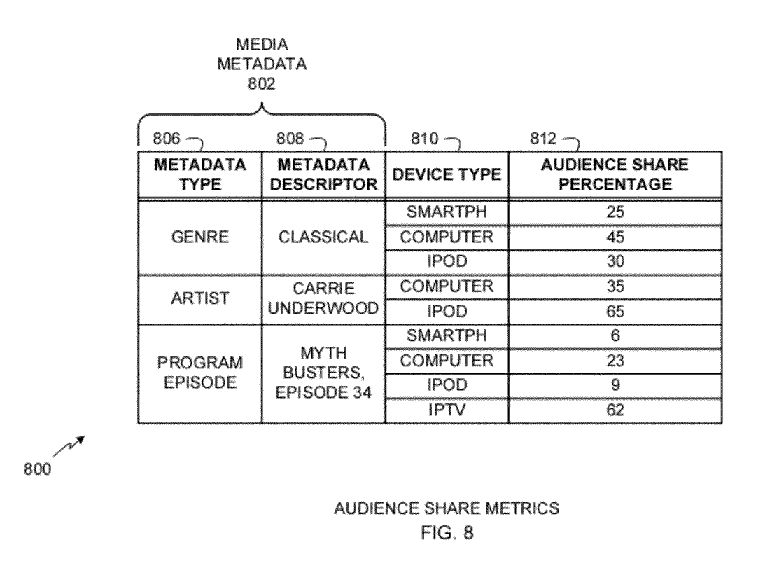

FIG. 8 depicts an example audience share metrics data structure 800 that may be used to store and report audience share metrics indicative of percentages of audiences exposed to the same media content via different device types. In the illustrated example, the audience share metrics data structure 800 may be part of the media exposure report 132 of FIGS. 1 and 2. As shown in FIG. 8, the example audience share metrics data structure 800 includes media metadata 802 stored as metadata types 806 (similar to the metadata types 218 of FIG. 2) and metadata descriptors 808 (similar to the metadata descriptors 220 of FIG. 2). The example audience share metrics data structure 800 also includes device types 810 and audience share percentages 812 for corresponding ones of the device types 810, metadata descriptors 808 and metadata types 806.

As shown in FIG. 8, of the audience exposed to classical music, 25% of the audience was exposed to the classical music via smart phones, 45% of the audience was exposed to the classical music via computers, and 30% of the audience was exposed to the classical music via IPOD® media devices. FIG. 8 also shows audience share metrics for different device types in association with artist type and program episode.

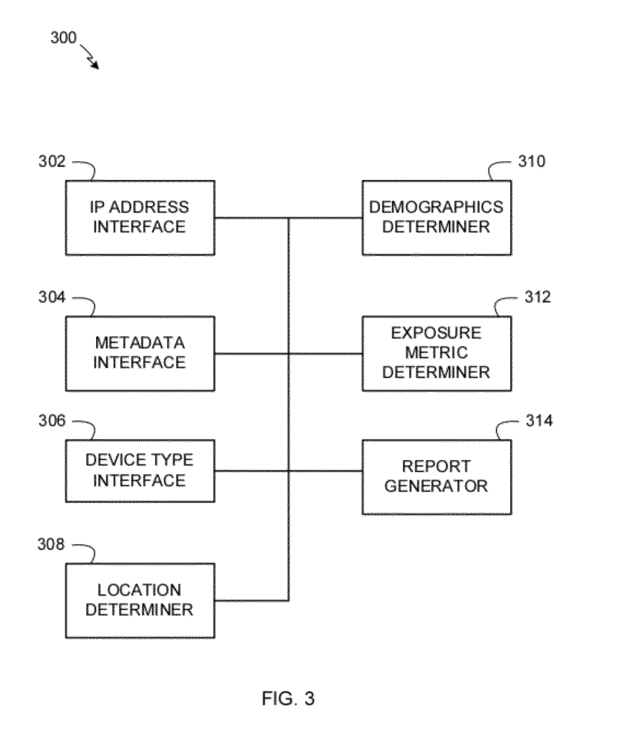

Turning now to FIG. 3, an example apparatus 300 is shown which may be used to perform example methods disclosed herein. In the following example, the apparatus 300 is implemented by the audience measurement entity 102 of FIG. 1. In the illustrated example of FIG. 3, the example apparatus 300 includes an example IP address interface 302, an example metadata interface 304, an example device type interface 306, an example location determiner 308, an example demographics determiner 310, an example exposure metric determiner 312, and an example report generator 314. While an example manner of implementing the apparatus 300 has been illustrated in FIG. 3, one or more of the elements, processes and/or devices illustrated in FIG. 3 may be combined, divided, re-arranged, omitted, eliminated and/or implemented in any other way. Further, the IP address interface 302, the metadata interface 304, the device type interface 306, the location determiner 308, the demographics determiner 310, the exposure metric determiner 312, and the report generator 314 and/or, more generally, the example apparatus 300 of FIG. 3 may be implemented by hardware, software, firmware and/or any combination of hardware, software and/or firmware. Thus, for example, any of the IP address interface 302, the metadata interface 304, the device type interface 306, the location determiner 308, the demographics determiner 310, the exposure metric determiner 312, and the report generator 314 and/or, more generally, the example apparatus 300 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the IP address interface 302, the metadata interface 304, the device type interface 306, the location determiner 308, the demographics determiner 310, the exposure metric determiner 312, and/or the report generator 314 are hereby expressly defined to include a computer readable medium such as a memory, DVD, CD, etc. storing the software and/or firmware. Further still, the example apparatus 300 of FIG. 3 may include one or more elements, processes and/or devices in addition to, or instead of, those illustrated in FIG. 3, and/or may include more than one of any or all of the illustrated elements, processes and devices.

Turning in detail to FIG. 3, the apparatus 300 is provided with the IP address interface 302 to receive IP addresses from monitored media devices such as the media devices 104 and 106 of FIG. 1. In the illustrated example, the IP address interface 302 stores the IP addresses received in the collection process in the batch data collection store 122. The media audience measurement entity 102 collects meter data from the meters 108a, 108b (FIG. 1) monitoring the monitored media devices 104, 106 during a media device data collection process.

To receive and process media metadata (e.g., the media metadata 204 of FIG. 2), the apparatus 300 of the illustrated example is provided with the metadata interface 304. For example, the metadata interface 304 may receive media metadata from monitored media devices such as the media devices 104 and 106 of FIG. 1. In the illustrated example, the metadata interface 304 stores the media metadata retrieved during a media device data collection process in the batch data collection store 122 in association with respective media device IP addresses. In the illustrated example of FIG. 3, the metadata interface 304 is also configured to retrieve metadata descriptive information from the metadata references store 128 of FIG. 1 in instances in which some or all of the media metadata is encoded using numeric values.

To receive and process device type information (e.g., the device type information 206 of FIG. 2), the apparatus 300 of the illustrated example is provided with the device type interface 306. The example device type interface 306 receives device type information from monitored media devices such as the media devices 104 and 106 of FIG. 1 during the media device data collection process. In the illustrated example, the device type interface 306 stores the device type information in the batch data collection store 122 in association with respective media device IP addresses providing the information.

To determine geographic locations of users (e.g., a user of the portable media device 104 and/or a user of the stationary media device 106 of FIG. 1), the apparatus 300 of the illustrated example is provided with the location determiner 308. The example location determiner 308 accesses the geographic locations store 124 of FIG. 1 to retrieve geographic location information based on IP addresses associated with media devices (e.g., the media devices 104 and 106 of FIG. 1) to, thereby, identify the geographic location(s) of the monitored media devices 104 and 106.

To determine demographics (e.g., the audience demographics 202 of FIG. 2) of audience members (e.g., a user of the portable media device 104 and/or a user of the stationary media device 106 of FIG. 1), the apparatus 300 of the illustrated example is provided with the demographics determiner 310. The example demographics determiner 310 accesses the demographics store 126 to retrieve demographics for users based on geographic locations of those users as determined by the location determiner 308 using IP addresses and the geographic locations store 124.

To determine media exposure and/or popularity measures (e.g., the media exposure/popularity measures 208 of FIG. 2), the apparatus 300 of the illustrated example is provided with the exposure metric determiner 312. The example exposure metric determiner 312 of FIG. 3 logs or tracks occurrences of different media metadata associated with each monitored media device, and groups the logged information based on geographic locations of audience members, audience member demographics information and/or device type information.

In some examples, the example exposure metric determiner 312 is configured to determine audience share metrics indicative of percentages of audiences for different device types that accessed the same media content. For example, the exposure metric determiner 312 may determine a particular percentage of an audience that was exposed to particular news content (or other media content) via smart phones and another percentage of the audience that was exposed to the same news content (or the same other media content) via stationary computers. Such audience percentages per device type can then be reported for comparative analysis by an end user or client.

To generate the media exposure report 132 of FIGS. 1 and 2, the apparatus 300 of the illustrated example is provided with the report generator 314. The example report generator 314 of FIG. 3 associates geographic location, demographics information (e.g., the audience demographics 202 of FIG. 2), media metadata (e.g., the media metadata 204 of FIG. 2) and/or device type information (e.g., the device type information 206 of FIG. 2) with corresponding exposure measures, popularity measures (e.g., the exposure/popularity measures 208 of FIG. 2), and/or audience share metrics (e.g., the audience share percentages 812 of FIG. 8) generated by the exposure metric determiner 312 based on the tracked occurrences of different media metadata.

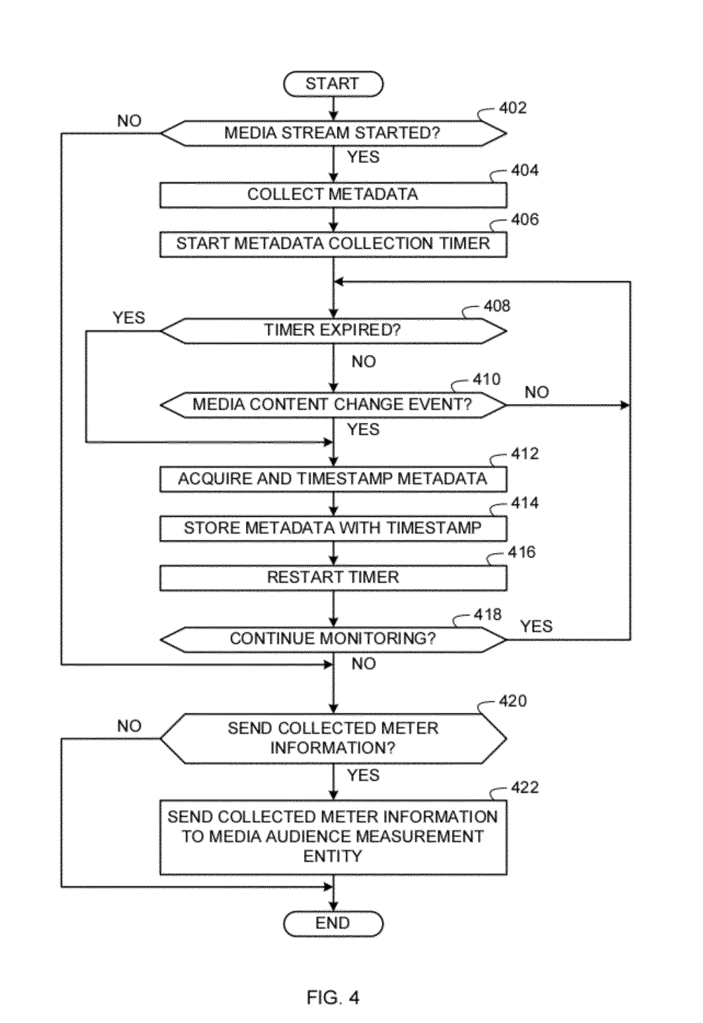

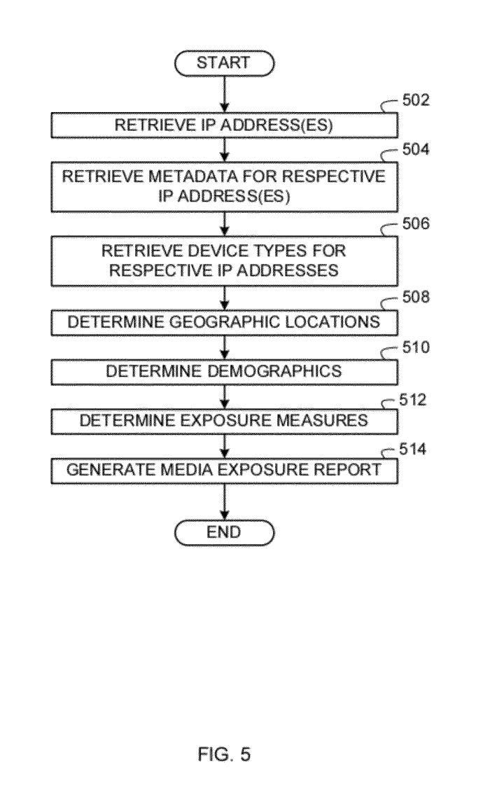

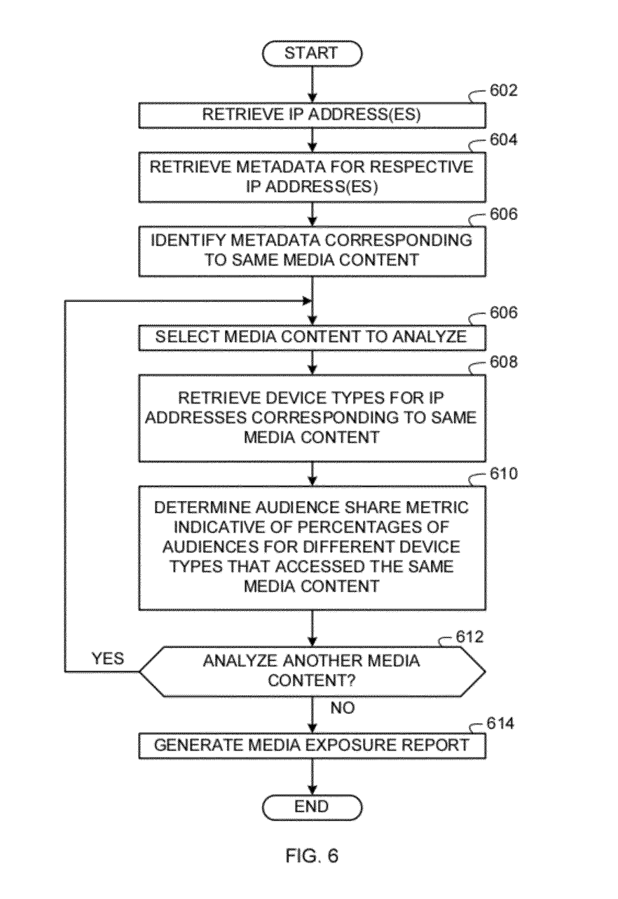

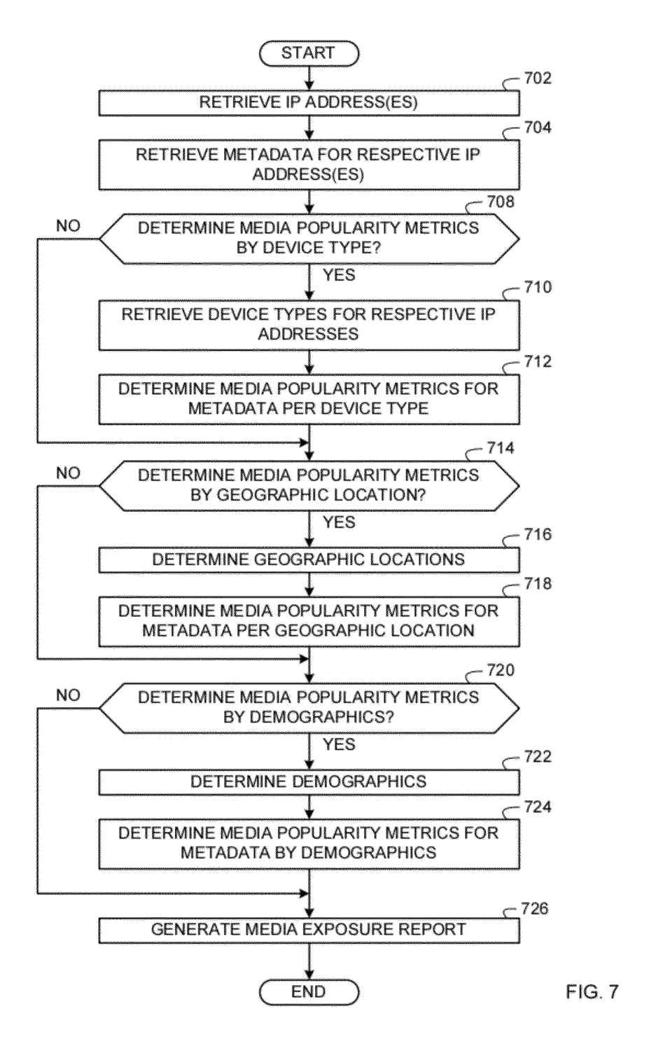

FIG. 4 is a flow diagram representative of example machine readable instructions that may be executed to collect media metadata from streaming media (e.g., the media streams 110a-b of FIG. 1) or locally stored media (e.g., the local media 114a-b of FIG. 1) at user devices (e.g., the portable media device 104 and/or the stationary media device 106 of FIG. 1). FIG. 5 is a flow diagram representative of example machine readable instructions that may be executed to determine media exposure measures based on media metadata, user demographics, and media delivery device types. FIG. 6 is a flow diagram representative of example machine readable instructions that may be executed to determine an audience share metric indicative of percentages of audiences for different device types that accessed the same media content. FIG. 7 is a flow diagram representative of example machine readable instructions that may be executed to measure popularities of media content across one or more of device type information, geographic locations of audience members, and/or audience member demographics.

The example processes of FIGS. 4-7 may be implemented using machine readable instructions that, when executed, cause a device (e.g., a programmable controller, processor, or other programmable machine or integrated circuit) to perform the operations shown in FIGS. 4-7. For instance, the example processes of FIGS. 4-7 may be performed using a processor, a controller, and/or any other suitable processing device. For example, the example processes of FIGS. 4-7 may be implemented using coded instructions stored on a tangible machine readable medium such as a flash memory, a read-only memory (ROM), and/or a random-access memory (RAM).

As used herein, the term tangible computer readable medium is expressly defined to include any type of computer readable storage and to exclude propagating signals. Additionally or alternatively, the example processes of FIGS. 4-7 may be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, the example processes of FIGS. 4-7 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, the example processes of FIGS. 4-7 may be implemented as any combination(s) of any of the foregoing techniques, for example, any combination of firmware, software, discrete logic and/or hardware.

Although the example processes of FIGS. 4-7 are described with reference to the flow diagram of FIGS. 4-7, other methods of implementing the processes of FIGS. 4-7 may be employed. For example, the order of execution of the blocks may be changed, and/or some of the blocks described may be changed, eliminated, sub-divided, or combined. Additionally, one or both of the example processes of FIGS. 4-7 may be performed sequentially and/or in parallel by, for example, separate processing threads, processors, devices, discrete logic, circuits, etc.

Turning in detail to FIG. 4, the example process is described with reference to the portable media device 104 of FIG. 1. However, the example process may be similarly implemented using the stationary media device 106 and/or any other suitable media device. Initially, the meter 108a of the portable media device 104 determines whether playback of the media stream 110a (FIG. 1) has started (block 402). Alternatively at block 402, the meter 108a may determine whether playback of the local media 114a has started.

If playback of the media stream 110a (or of the local media 114a) has started (block 402), the meter 108a collects and timestamps media metadata (block 404) from the media being played back. The meter 108a then starts a metadata collection timer (block 406) to trigger periodic metadata collection events.

At some later time, the meter 108a determines whether the timer has expired (block 408). If the timer has not expired (block 408), the meter 108a determines whether a media content change event has occurred (block 410). A media content change event may be a tuning change in which an audience member has tuned to a different Internet streaming radio (or television) station. Additionally or alternatively, a media content change event may occur when an audience member selects a different song or video for streaming in, for example, an on-demand fashion. Additionally or alternatively, a media content change event may occur when an audience member selects a different song or video for playback from the local media 114a.

If a media content change event has occurred (block 410) or if the timer has expired (block 408), control advances to block 412, at which the meter 108a acquires and timestamps media metadata (block 412) (e.g., the media metadata 204 of FIG. 2). In the illustrated example, the collected media metadata is media exposure information indicative of media content to which a user was exposed. The meter 108a stores the acquired media metadata in association with its timestamp (block 414) indicative of a time of acquiring the media metadata. For instances in which the media metadata was acquired at block 412 in response to a content change event, the timestamp is also indicative of when the content change event occurred. In the illustrated example, the meter 108a sets a content change event flag or bit in association with timestamps that are also indicative of times at which content change events occurred. The meter 108a restarts the metadata collection timer 414 (block 416) and determines whether to continue monitoring. For example, if the media playback stops, the meter 108a may determine not to continuing monitoring.

If the meter 108a determines that it should continue monitoring for media metadata (block 418), control returns to block 408. Otherwise, the meter 108a determines whether to send its collected meter information (e.g., IP address, media metadata, device type information) to the media audience measurement entity 102 (FIG. 1) (block 420). If the meter 108a determines that it should export its collected meter information (block 420), the meter 108a sends its collected meter information to the media audience measurement entity 102 (block 422). For example, the meter 108a may be configured to upload its collected meter information at pre-defined times or when a threshold amount of collected meter information has been collected.

After sending the collected meter information to the media audience measurement entity 102 at block 422, or, if at block 420, the meter 108a determines that it should not send its collected meter information to the media audience measurement entity 102, the example process of FIG. 4 ends.

Turning now to FIG. 5, the depicted example process may be executed to implement the example apparatus 300 of FIG. 3 to generate the media exposure report 132 of FIG. 1. Initially, the IP address interface 302 (FIG. 3) retrieves one or more IP addresses (block 502). For example, the IP address interface 302 may retrieve one or more IP address(es) from the batch data collection store 122 of FIG. 1. In some examples, a user may specify which IP addresses are of interest for generating the media exposure report 132 of FIG. 1. In other examples, the apparatus 300 may be configured to automatically and periodically or aperiodically generate the media exposure report 132 for all of the IP addresses represented in the batch data collection store 122. The metadata interface 304 (FIG. 3) retrieves respective media metadata for corresponding ones of the IP addresses (block 504). For example, the metadata interface 304 may retrieve the media metadata from the batch data collection store 122. In the illustrated example, the media metadata is representative of media exposure information indicative of media content to which users associated with the IP addresses were exposed. The device type interface 306 (FIG. 3) retrieves device type information for respective ones of the IP addresses (block 506). For example, the device type interface 306 may retrieve the device type information from the batch data collection store 122.

In some example implementations, the IP address(es), the media metadata, and the device type information retrieved at blocks 502, 504, and 506 may be IP address(es), media metadata, and device type information corresponding to timestamps within a specified date/time range. In this manner, the apparatus 300 may generate media exposure reports pertaining to media exposures that occurred at or within particular dates/times.

The example location determiner 306 of FIG. 3 determines geographic locations corresponding to the one or more IP addresses (block 508). For example, the location determiner 306 may submit queries to the geographic locations store 124 (FIG. 1) requesting geographic location identifiers for the IP address(es) retrieved at block 502. The example demographics determiner 310 of FIG. 3 determines demographics of the audience member(s) (block 510) associated with the IP address(es) retrieved at block 502. For example, the demographics determiner 310 may query the demographics store 126 (FIG. 1) to retrieve demographics information based on the geographic location(s) determined at block 508.

The example exposure metric determiner 312 of FIG. 3 determines media exposure measures (block 512) based on the media metadata retrieved at block 504. In some examples, the exposure metric determiner 312 determines media exposure measures based on different demographics associated with the collected media metadata and/or different device types associated with the collected media metadata. The example report generator 314 of FIG. 3 generates the media exposure report 132 (FIGS. 1 and 2) (block 514). For example, the report generator 314 may generate the media exposure report 132 as shown in FIG. 2 including the demographics information 202, the media metadata 204, the device type information 206, and the exposure/popularity measures 208. Alternatively, the report generator 314 may generate the media exposure report 132 omitting the audience demographics information 202 and/or omitting the device type information 206. The example process of FIG. 5 then ends.

FIG. 6 is a flow diagram that may be used to implement the example apparatus 300 of FIG. 3 to determine an audience share metric indicative of percentages of audiences for different device types that accessed the same media content. Initially, the IP address interface 302 (FIG. 3) retrieves one or more IP addresses (block 602). For example, the IP address interface 302 may retrieve one or more IP address(es) from the batch data collection store 122 of FIG. 1. In some examples, a user may specify which IP addresses are of interest for generating the media exposure report 132 of FIG. 1. In other examples, the apparatus 300 may be configured to automatically and periodically or aperiodically generate the media exposure report 132 for all of the IP addresses represented in the batch data collection store 122. In the illustrated example, the media metadata represents media exposure information indicative of media content to which users associated with the IP addresses were exposed. In some example implementations, the IP addresses retrieved at block 602 may be IP addresses corresponding to timestamps within a specified date/time range. In this manner, the apparatus 300 may generate audience share metrics pertaining to media exposures that occurred at or within particular dates/times.

The metadata interface 304 (FIG. 3) retrieves respective media metadata for corresponding ones of the IP addresses (block 604). For example, the metadata interface 304 may retrieve the media metadata from the batch data collection store 122. The metadata interface 304 identifies metadata corresponding to the same media content (block 606). For example, the metadata interface 304 analyzes the metadata based on, for example, genre, artist, song title, album/CD name, movie name, television program episode, television program title, game title, etc. and groups the metadata into respective groups that represent the same media content (e.g., the same genre, the same artist, the same song title, the same album/CD name, movie name, television program episode, television program title, game title, etc.). The apparatus 300 selects a media content to analyze (block 606). For example, a user may specify that the apparatus 300 should analyze particular media content (e.g., a particular genre, a particular song title, a particular artist, a particular album/CD name, movie name, television program episode, television program title, game title, etc.) or the apparatus 300 may be configured to analyze all identified media content and cycle through each media content automatically.

For the selected media content, the device type interface 306 (FIG. 3) retrieves device type information corresponding to the IP addresses for which metadata collected at block 604 corresponds to the media content selected at block 606 (block 608). The example device type interface 306 may retrieve such device type information from the batch data collection store 122. The exposure metric determiner 312 (FIG. 3) determines an audience share metric (e.g., the audience share percentages 812 of FIG. 8) indicative of percentages of audiences for the different device types retrieved at block 608 that accessed the same media content selected at block 606 (block 610). For example, the audience share metric may indicate that a particular percentage of an audience was exposed to a news program via smart phone, while another percentage of the audience was exposed to the same news program via a stationary/home computer. The audience share metric may indicate percentages of audiences exposed to the same media content across any number of different device types (e.g., as shown in the audience share metrics data structure 800 of FIG. 8).

The apparatus 300 determines whether it should analyze another media content (block 612). Such decision may be user-specified or made automatically by the apparatus 300 based on a pre-programmed preference indicating which media content(s) to analyze. If the apparatus 300 determines that it should analyze another media content, control returns to block 606. Otherwise, control advances to block 614, and the report generator 314 generates the media exposure report 132 to include an audience share metrics data structure (e.g., the audience share metrics data structure 800 of FIG. 8) including the determined audience share metric(s) (block 614). The example process of FIG. 6 then ends.

FIG. 7 is a flow diagram representative of example machine readable instructions that may be executed to implement the example apparatus 300 of FIG. 3 to measure popularities of media content (i.e., media popularity metrics) across one or more of device type information, geographic locations of audience members, and/or audience member demographics. Initially, the IP address interface 302 (FIG. 3) retrieves one or more IP addresses (block 702). For example, the IP address interface 302 may retrieve one or more IP address(es) from the batch data collection store 122 of FIG. 1. In some examples, a user may specify which IP addresses are of interest for generating the media exposure report 132 of FIG. 1. In other examples, the apparatus 300 may be configured to automatically and periodically or aperiodically generate the media exposure report 132 for all of the IP addresses represented in the batch data collection store 122. In some example implementations, the IP addresses retrieved at block 702 may be IP addresses corresponding to timestamps within a specified date/time range. In this manner the apparatus 300 may generate media popularity metrics pertaining to media exposures that occurred at or within particular dates/times.

The metadata interface 304 (FIG. 3) retrieves respective media metadata for corresponding ones of the IP addresses (block 704). For example, the metadata interface 304 may retrieve the media metadata from the batch data collection store 122. In the illustrated example, the media metadata represents media exposure information indicative of media content to which users associated with the IP addresses were exposed.

The apparatus 300 determines whether it should determine media popularity metrics based on device type (block 708). For example, the apparatus 300 may be pre-programmed to determine media popularity metrics based on device type or a user may specify that the apparatus 300 should determine media popularity metrics based on device type. If the apparatus 300 determines that it should determine media popularity metrics based on device type (block 708), the device type interface 306 (FIG. 3) retrieves device type information for respective ones of the IP addresses retrieved at block 702 (block 710). For example, the device type interface 306 may retrieve the device type information from the batch data collection store 122. The exposure metric determiner 312 then determines a media popularity metric for each category or group of the metadata (e.g., genre, artist, song title, album/CD, television program, game title, transmitting station/server site ID, etc.) retrieved at block 704 based on the device types through which corresponding media was accessed (block 712).

After determining the media popularity metrics based on device type at block 712, or, if the apparatus 300 determined at block 708 to not determine media popularity metrics based on device type, control advances to block 714. The apparatus 300 determines whether it should determine media popularity metrics based on geographic location (block 714). For example, the apparatus 300 may be pre-programmed to determine media popularity metrics based on geographic location or a user may specify that the apparatus 300 should determine media popularity metrics based on geographic location. If the apparatus 300 determines that it should determine media popularity metrics based on geographic location (block 714), the location determiner 308 (FIG. 3) retrieves geographic location information for respective ones of the IP addresses retrieved at block 702 (block 716). For example, the location determiner 306 may submit queries to the geographic locations store 124 (FIG. 1) requesting geographic location identifiers for the IP address(es) retrieved at block 702. The exposure metric determiner 312 then determines a media popularity metric for each category or group of the metadata (e.g., genre, artist, song title, album/CD, television program, game title, transmitting station/server site ID, etc.) retrieved at block 704 based on the geographic locations at which corresponding media was accessed (block 718).

After determining the media popularity metrics based on geographic location at block 718, or, if the apparatus 300 determined at block 714 to not determine media popularity metrics based on geographic location, control advances to block 720. The apparatus 300 determines whether it should determine media popularity metrics based on demographics (e.g., one or more of age group, gender, household income, demographic segment, etc.) (block 720). For example, the apparatus 300 may be pre-programmed to determine media popularity metrics based on demographics or a user may specify that the apparatus 300 should determine media popularity metrics based on demographics. If the apparatus 300 determines that it should determine media popularity metrics based on demographics (block 720), the example demographics determiner 310 of FIG. 3 determines demographics of the audience member(s) (block 722) associated with the IP address(es) retrieved at block 702. For example, the demographics determiner 310 may query the demographics store 126 (FIG. 1) to retrieve demographics information based on the geographic location(s) associated with the IP address(es). The exposure metric determiner 312 then determines a media popularity metric for each category or group of the metadata (e.g., genre, artist, song title, album/CD, television program, game title, transmitting station/server site ID, etc.) retrieved at block 704 based on the demographics for which corresponding media was accessed (block 724).

After determining the media popularity metrics based on demographics at block 724, or, if the apparatus 300 determines at block 720 to not determine media popularity metrics based on demographics, control advances to block 726. The report generator 314 generates the media exposure report 132 to store the one or more of the media popularity metrics (e.g., as the exposure/popularity measures 208 of FIG. 2) determined by the exposure metric determiner 312 (block 726). The example process of FIG. 7 then ends.

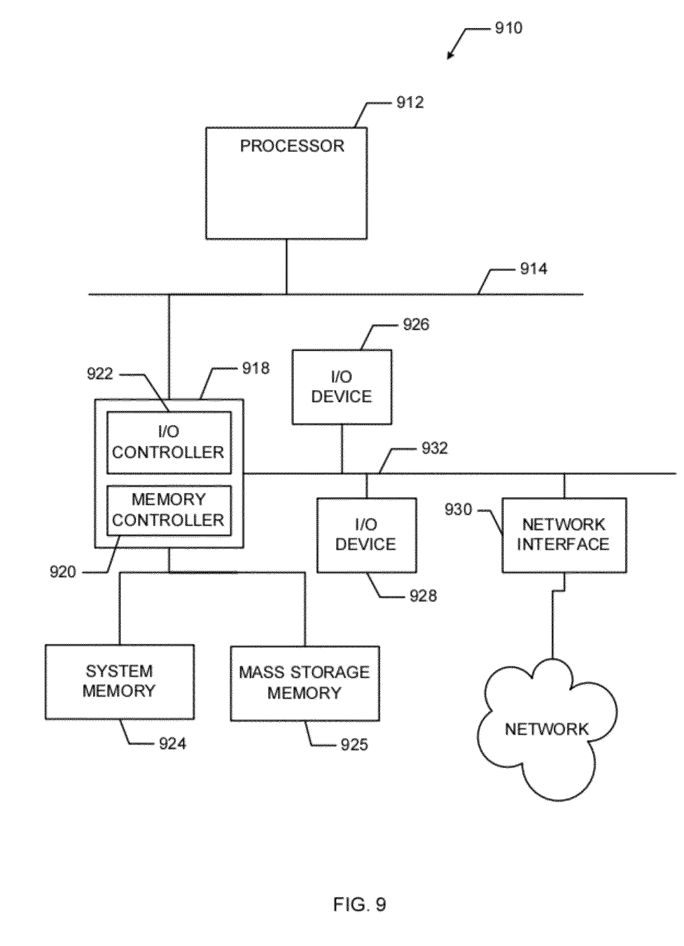

FIG. 9 is a block diagram of an example processor system 910 that may be used to implement the example apparatus 300 of FIG. 3 and/or the example meters 108a-b of FIG. 1 to perform example methods described herein. As shown in FIG. 9, the processor system 910 includes a processor 912 that is coupled to an interconnection bus 914. The processor 912 may be any suitable processor, processing unit, or microprocessor. Although not shown in FIG. 9, the system 910 may be a multi-processor system and, thus, may include one or more additional processors that are identical or similar to the processor 912 and that are communicatively coupled to the interconnection bus 914.

The processor 912 of FIG. 9 is coupled to a chipset 918, which includes a memory controller 920 and an input/output (I/O) controller 922. A chipset provides I/O and memory management functions as well as a plurality of general purpose and/or special purpose registers, timers, etc. that are accessible or used by one or more processors coupled to the chipset 918. The memory controller 920 performs functions that enable the processor 912 (or processors if there are multiple processors) to access a system memory 924 and a mass storage memory 925.

In general, the system memory 924 may include any desired type of volatile and/or non-volatile memory such as, for example, static random access memory (SRAM), dynamic random access memory (DRAM), flash memory, read-only memory (ROM), etc. The mass storage memory 925 may include any desired type of mass storage device including hard disk drives, optical drives, tape storage devices, etc.

The I/O controller 922 performs functions that enable the processor 912 to communicate with peripheral input/output (I/O) devices 926 and 928 and a network interface 930 via an I/O bus 932. The I/O devices 926 and 928 may be any desired type of I/O device such as, for example, a keyboard, a video display or monitor, a mouse, etc. The network interface 930 may be, for example, an Ethernet device, an asynchronous transfer mode (ATM) device, an 802.11 device, a digital subscriber line (DSL) modem, a cable modem, a cellular modem, etc. that enables the processor system 910 to communicate with another processor system.

While the memory controller 920 and the I/O controller 922 are depicted in FIG. 9 as separate functional blocks within the chipset 918, the functions performed by these blocks may be integrated within a single semiconductor circuit or may be implemented using two or more separate integrated circuits.

Although the above discloses example methods, apparatus, systems, and articles of manufacture including, among other components, firmware and/or software executed on hardware, it should be noted that such methods, apparatus, systems, and articles of manufacture are merely illustrative and should not be considered as limiting. For example, it is contemplated that any or all of these hardware, firmware, and/or software components could be embodied exclusively in hardware, exclusively in firmware, exclusively in software, or in any combination of hardware, firmware, and/or software. Accordingly, while the above describes example methods, apparatus, systems, and articles of manufacture, the examples provided are not the only ways to implement such methods, apparatus, systems, and articles of manufacture.

Although certain example methods, apparatus, systems, and articles of manufacture have been described herein, the scope of coverage of this patent is not limited thereto. On the contrary, this patent covers all methods, apparatus and articles of manufacture fairly falling within the scope of the claims of this patent.

1. A method to monitor streaming media transmissions received at a media device, comprising:
extracting and timestamping metadata from streaming media transmissions received at a media device, the metadata identifying at least one of a genre or an artist;
identifying demographic information associated with a user of the media device based on an internet protocol (IP) address associated with the media device; and
generating media exposure information indicating exposure of a demographic segment to at least one of the genre or the artist based on the demographic information and the metadata.

2. A method as defined in claim 1, further comprising detecting and timestamping content change events in association with corresponding ones of the extracted metadata, and generating the media exposure information based on the timestamped content change events.

3. A method as defined in claim 2, wherein the timestamped content change events are tuning change events caused by the user tuning to different Internet streaming radio stations.

4. A method as defined in claim 1, further comprising associating the media exposure information with a device type of the media device.

5. A method as defined in claim 4, wherein the device type is selectable from a list including a portable media device and a stationary media device.

6. A method as defined in claim 1, wherein the IP address is a public IP address assigned by an Internet service provider to a gateway through which the media device accesses the Internet to receive the streaming media transmissions.

7. A method as defined in claim 1, wherein the streaming media transmissions include at least one of audio content or video content.

8. A method as defined in claim 1, wherein generating the media exposure information includes generating a media popularity metric indicative of a popularity of the at least one of the genre or the artist among at least one of an age group, a demographic segment, or a gender.

9. An apparatus to monitor streaming media transmissions received at a media device, comprising:
a meter to extract and timestamp metadata from streaming media transmissions received at a media device, the metadata identifying at least one of a genre or an artist;
a demographics determiner to identify demographic information associated with a user of the media device based on an internet protocol (IP) address associated with the media device; and
an exposure metric determiner to generate media exposure information indicating exposure of a demographic segment to at least one of the genre or the artist based on the demographic information and the metadata.

10. An apparatus as defined in claim 9, wherein the meter is to detect and timestamp content change events in association with corresponding ones of the extracted metadata, the exposure metric determiner further to generate the media exposure information based on the timestamped content change events.

11. An apparatus as defined in claim 10, wherein the timestamped content change events are tuning change events caused by the user tuning to different Internet streaming radio stations.

12. An apparatus as defined in claim 9, wherein the exposure metric determiner is to associate the media exposure information with a device type of the media device.

13. An apparatus as defined in claim 12, wherein the device type is selectable from a list including a portable media device and a stationary media device.

14. An apparatus as defined in claim 9, wherein the IP address is a public IP address assigned by an Internet service provider to a gateway through which the media device accesses the Internet to receive the streaming media transmissions.

15. An apparatus as defined in claim 9, wherein the streaming media transmissions include at least one of audio content or video content.

16. An apparatus as defined in claim 9, wherein the exposure metric determiner is to generate a media popularity metric indicative of a popularity of the at least one of the genre or the artist among at least one of an age group, a demographic segment, or a gender.

17.-24. (canceled)

25. A method to monitor media exposure for streaming media transmissions received at media devices, comprising:
receiving first media exposure information associated with first streaming media received at a first device of a first device type, the first media exposure information generated based on first metadata extracted from the first streaming media at the first device;
receiving second media exposure information associated with second streaming media received at a second device of a second device type, the second media exposure information generated based on second metadata extracted from the second streaming media at the second device, the first and second streaming media corresponding to a same program content; and
determining an audience share metric indicating a percentage of audience of the second device type accessing the same program content as audience of the first device type based on the first and second media exposure information.

26. A method as defined in claim 25, further comprising:
retrieving first demographic information associated with a first user of the first device based on a first internet protocol (IP) address associated with the first device;
retrieving second demographic information associated with a second user of the second device based on a second IP address associated with the second device; and
associating the first demographic information with the first media exposure information and the second demographic information with the second media exposure information.

27. A method as defined in claim 26, wherein the first IP address is a public IP address assigned by an Internet service provider to a gateway through which the first device accesses the Internet to receive the first streaming media.

28. A method as defined in claim 25, wherein the same program content is defined by at least one of an artist name, a genre, a song title, or a television program title.

29.-45. (canceled)
